(19) United States
(12) Patent Application Publication
(10) Pub. No.: US 2026/0128371 A1
(43) Pub. Date: May 7, 2026

(54) COMPOSITION FOR FORMING QUASI-SOLID-STATE ELECTROLYTE AND SECONDARY BATTERY

(71) Applicants: SK ON CO., LTD., Seoul (KR); INDUSTRY-ACADEMIC COOPERATION FOUNDATION, YONSEI UNIVERSITY, Seoul (KR)

(72) Inventors: Bit Na CHOI, Daejeon (KR); Sang Young LEE, Seoul (KR); Hyun Seok MOON, Seoul (KR)

(21) Appl. No.: 19/380,961

(22) Filed: Nov. 6, 2025

(30) Foreign Application Priority Data
Nov. 7, 2024 (KR) 10-2024-0157301

(51) Int. Cl. H01M 10/0565; H01M 10/052

(52) U.S. Cl. CPC H01M 10/0565; H01M 10/052; H01M 2300/0082

(57) ABSTRACT

A composition for forming a quasi-solid-state electrolyte according to the present disclosure includes a liquid electrolyte including a lithium salt and an organic solvent, a first monomer having an ionic functional group, a second monomer different from the first monomer and having a crosslinkable functional group, and an initiator. A secondary battery according to the present disclosure includes an anode, a cathode disposed opposite to the anode, and an electrolyte layer disposed between the anode and the cathode and including a cured product of the composition for forming a quasi-solid-state electrolyte. The cathode includes a porous sulfur-containing matrix having a plurality of pores and a cured product of the composition for forming a quasi-solid-state electrolyte within the plurality of pores.

### CROSS-REFERENCE TO RELATED APPLICATION

This application claims priority to Korean Patent Application No. 10-2024-0157301 filed on Nov. 7, 2024 in the Korean Intellectual Property Office (KIPO), the entire disclosure of which is incorporated by reference herein.

### BACKGROUND OF THE INVENTION

### 1. Field of the Invention

The present disclosure relates to a composition for forming a quasi-solid-state electrolyte and a secondary battery.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, a nickel-hydrogen battery, and a lithium-sulfur battery.

Since commercially available secondary batteries mainly use liquid electrolytes, there are safety issues such as leakage, ignition, and explosion due to sudden environmental changes such as temperature fluctuations or external impacts. To address these problems, research has been conducted to solidify the electrolyte, thereby enhancing stability and increasing energy density.

All-solid-state batteries may include solid-state electrolytes such as gel polymers, oxides, sulfides, or composite polymers as electrolytes. Accordingly, stability against ignition and explosion caused by external impacts or external environmental fluctuations may be enhanced.

### SUMMARY OF THE INVENTION

An object of the present disclosure is to provide a composition for forming a quasi-solid-state electrolyte that enables the formation of a quasi-solid-state electrolyte having improved electrochemical properties.

Another object of the present disclosure is to provide a secondary battery including a cured product of the composition for forming a quasi-solid-state electrolyte.

A composition for forming a quasi-solid-state electrolyte according to the present disclosure includes: a liquid electrolyte including a lithium salt and an organic solvent; a first monomer having an ionic functional group; a second monomer different from the first monomer and having a crosslinkable functional group; and an initiator.

In exemplary embodiments, the first monomer may include an anionic functional group; a cationic functional group; or both anionic and cationic functional groups.

In exemplary embodiments, the first monomer may include a nitrogen-based cationic functional group and a sulfur-based anionic functional group.

In exemplary embodiments, the first monomer may include 3-(triallylammonio)propanesulfonate.

In exemplary embodiments, the content of the first monomer may be 0.1% by weight to 5% by weight based on the total weight of the composition.

In exemplary embodiments, the crosslinkable functional group may include (meth)acrylate group.

In exemplary embodiments, the second monomer may include at least one selected from the group consisting of bisphenol A ethoxylated di(meth)acrylate, ethylene glycol di(meth)acrylate, triethylene glycol di(meth)acrylate, ethoxylated trimethylolpropane tri(meth)acrylate, (meth)acrylic acid, carboxyethyl di(meth)acrylate, cyano(meth)acrylic acid, propylene glycol di(meth)acrylate, polyurethane di(meth)acrylate, neopentyl glycol di(methacrylate, isobornyl di(meth)acrylate, isophorone di(meth)acrylate, hexamethylene di(meth)acrylate, phenyl glycidyl ether di(meth)acrylate, and tetraethylene glycol di(meth)acrylate.

In exemplary embodiments, the content of the second monomer may be 5% by weight to 20% by weight based on the total weight of the composition.

In exemplary embodiments, the ratio of the weight of the second monomer to the weight of the first monomer based on the total weight of the composition may be 1 to 10.

In exemplary embodiments, the initiator may include a thermal initiator or a photoinitiator.

In exemplary embodiments, the content of the initiator may be 0.1 to 10 parts by weight based on 100 parts by weight of the total amount of the first monomer and the second monomer.

In exemplary embodiments, the lithium salt may include a first lithium salt including an organic anion and a second lithium salt including an inorganic anion.

In exemplary embodiments, the organic solvent may include a cyclic ether solvent and a linear ether solvent.

A secondary battery according to the present disclosure includes: an anode; a cathode disposed opposite to the anode; and an electrolyte layer disposed between the anode and the cathode and including a cured product of a composition for forming a quasi-solid-state electrolyte. The cathode includes a porous sulfur-containing matrix having a plurality of pores and a cured product of the composition for forming a quasi-solid-state electrolyte within the plurality of pores. The composition for forming a quasi-solid-state electrolyte includes: a liquid electrolyte including a lithium salt and an organic solvent; a first monomer having an ionic functional group; a second monomer different from the first monomer and having a crosslinkable functional group; and an initiator.

In exemplary embodiments, the cured product of the composition for forming a quasi-solid-state electrolyte may include a copolymer of the first monomer and the second monomer.

The cured product of the composition for forming a quasi-solid-state electrolyte according to exemplary embodiments of the present disclosure may include a copolymer having ionic functional groups. Byproducts (e.g., lithium polysulfide) that may be formed during repeated charge and discharge cycles of a battery including the cured product can be captured by the ionic functional groups. Accordingly, the cycle life characteristics of the battery may be improved.

The secondary battery according to exemplary embodiments of the present disclosure may include an electrolyte layer and electrodes having improved ionic conductivity and stability. Accordingly, the cycle life characteristics of the battery may be improved.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic cross-sectional view illustrating a secondary battery according to an exemplary embodiment; and

FIG. 2 is a graph illustrating the capacity and coulombic efficiency as a function of the number of cycles for the batteries of Example 1, and Comparative Examples 1 and 2.

### DETAILED DESCRIPTION OF THE INVENTION

According to the present disclosure, there is provided a composition for forming a quasi-solid-state electrolyte including a liquid electrolyte, an ionic monomer, and a crosslinking monomer. According to the present disclosure, a secondary battery including a cured product of the composition is also provided.

Hereinafter, exemplary embodiments of the present disclosure will be described in detail. However, these embodiments are merely illustrative, and the present disclosure is not limited to the specific embodiments described as examples.

The composition for forming a quasi-solid-state electrolyte (hereinafter, abbreviated as “composition”) according to exemplary embodiments may include a first monomer. The first monomer has ionic functional groups. Accordingly, an electrolyte layer having high ion conductivity may be implemented. In addition, the ionic functional groups of the first monomer may capture lithium polysulfides, which are byproducts formed during the charge and discharge of a lithium-sulfur battery, thereby improving the cycle life characteristics of the battery.

In exemplary embodiments, the first monomer may include an anionic functional group; a cationic functional group; or both anionic and cationic functional groups. In some embodiments, the first monomer may include both anionic and cationic functional groups, for example, a zwitterionic compound.

The anionic functional group may include, for example, sulfonate, sulfinate, carbonate, carboxylate, phosphate, alkoxide, thioalkoxide, cyanide, nitrite or the like.

The cationic functional group may include, for example, primary ammonium (RNH₃⁺), secondary ammonium (R₂NH₂⁺), tertiary ammonium (R₃NH⁺), quaternary ammonium (R₄N⁺), phosphonium, imidazolium or the like.

In exemplary embodiments, the first monomer may include at least one ionic functional group. When the first monomer includes a plurality of ionic functional groups, each of the plurality of ionic functional groups may independently be an anionic functional group or a cationic functional group.

In exemplary embodiments, the first monomer may include a nitrogen-based cationic functional group and a sulfur-based anionic functional group. For example, the nitrogen-based cationic functional group may include primary ammonium (RNH₃⁺), secondary ammonium (R₂NH₂⁺), tertiary ammonium (R₃NH⁺), quatemary ammonium (R₄N⁺), imidazolium, or the like, and the sulfur-based anionic functional group may include sulfonate, sulfinate, thioalkoxide or the like.

The first monomer may further include a crosslinkable functional group different from the ionic functional group. The crosslinkable functional group may undergo a polymerization reaction with the crosslinkable functional group of a second monomer described below to form a copolymer. The crosslinkable functional group may include, for example, a carbon-carbon double bond, a (meth)acrylate group or the like.

In exemplary embodiments, the first monomer may include a counter ion of the ionic functional group. For example, when the first monomer includes a cationic functional group, it may include Br, Cl, I⁻, (CF₃SO₂)₂N⁻, (FSO₂)₂N⁻; CF₃SO₃⁻ or the like. For example, when the first monomer includes an anionic functional group, it may include a cation such as a metal salt.

In exemplary embodiments, the first monomer may be represented by Formula 1 below.

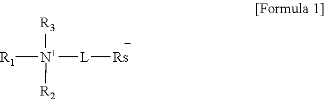

In Formula 1, R₁ to R₃ may each independently be an alkenyl group having 2 to 5 carbon atoms, L may be an alkylene group having 1 to 5 carbon atoms and Rₛ may be a sulfur-based anionic functional group.

In exemplary embodiments, the first monomer may include 3-(triallylammonio) propanesulfonate represented by Formula 2 below.

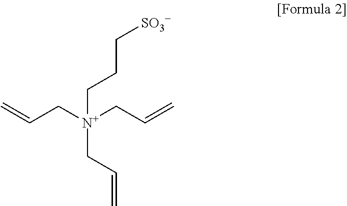

In exemplary embodiments, the content of the first monomer may be 0.1% by weight (“wt %”) to 5 wt % based on the total weight of the composition.

In some embodiments, the content of the first monomer may be 0.5 wt % to 4.5 wt %, or 2 wt % to 4 wt % based on the total weight of the composition.

Within the above range, the cured product of the composition may have improved ionic conductivity, and the capacity of a battery including the cured product of the composition may remain high even during repeated charge and discharge cycles.

The composition for forming a quasi-solid-state electrolyte according to exemplary embodiments may include a second monomer that is different from the first monomer and has a crosslinkable functional group. The second monomer may undergo polymerization with the first monomer to form a copolymer.

The second monomer may not include an ionic functional group. Therefore, it is possible to prevent the copolymer of the first monomer and the second monomer from exhibiting excessive ionicity, which could otherwise decrease the ionic conductivity of the electrolyte layer.

In exemplary embodiments, the second monomer may include at least one crosslinkable functional group. In some embodiments, the second monomer may include two or more crosslinkable functional groups. The second monomer may be a multifunctional monomer including two to six crosslinkable functional groups. When the second monomer includes two or more crosslinkable functional groups, the plurality of crosslinkable functional groups may be identical or different.

In exemplary embodiments, the crosslinkable functional group may be the same as that described for the first monomer. For example, the crosslinkable functional group may be a (meth)acrylate group.

In exemplary embodiments, the second monomer may include bisphenol A ethoxylated di(meth)acrylate, ethylene glycol di(meth)acrylate, triethylene glycol di(meth)acrylate, ethoxylated trimethylolpropane tri(meth)acrylate, (meth)acrylic acid, carboxyethyl di(meth)acrylate, cyano(meth)acrylic acid, propylene glycol di(meth)acrylate, polyurethane di(meth)acrylate, neopentyl glycol di(meth)acrylate, isobornyl di(meth)acrylate, isophorone di(meth)acrylate, hexamethylene di(meth)acrylate, phenyl glycidyl ether di(meth)acrylate, or tetraethylene glycol di(meth)acrylate. For example, the second monomer may include ethoxylated trimethylolpropane triacrylate. These compounds may be used alone or in combination of two or more thereof.

In exemplary embodiments, the content of the second monomer may be 5 wt % to 20 wt % based on the total weight of the composition. In some embodiments, the content of the second monomer may be 7 wt % to 15 wt % or 9 wt % to 12 wt % based on the total weight of the composition. Within this range, the electrolyte layer including the cured product of the composition may have improved durability.

In exemplary embodiments, the ratio of the weight of the second monomer to the weight of the first monomer based on the total weight of the composition may be 1 to 10. In some embodiments, the ratio of the weight of the second monomer to the weight of the first monomer based on the total weight of the composition may be 2 to 7 or 3 to 4. Within this range, the ion content per unit of the copolymer of the first monomer and the second monomer may be appropriately adjusted, thereby improving the ionic conductivity of the electrolyte layer while enhancing the cycle life characteristics of the battery.

The composition for forming a quasi-solid-state electrolyte according to exemplary embodiments may include a liquid electrolyte. The liquid electrolyte may include a lithium salt and an organic solvent and may serve as a dispersion medium for the first monomer and the second monomer.

In exemplary embodiments, the lithium salt may include one or more lithium salt compounds. For example, the lithium salt may be represented as Li⁺X⁻; and non-limiting examples of an anion (X⁻) of the lithium salt may include PF₆⁻, F⁻, Cl⁻, Br⁻, I⁻, NO₃⁻, N(CN)₂⁻, ClO₄⁻, (CF₃)₂PF₄⁻, (CF₃)₃⁻ PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (F₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂, SCN⁻, (CF₃CF₂SO₂)₂N⁻, BF₄⁻, B(C₂O₄)₂⁻, BF₂(C₂O₄)⁻, B(C₃H₂O₄)₂⁻, BF₂(C₃H₂O₄)⁻, B(C₃H₂O₄F)₂⁻, B(C₃F₂O₄)₂⁻, etc. The anions may be used alone or in combination of two or more thereof as lithium salts.

In exemplary embodiments, the lithium salt may include a first lithium salt including an organic anion and a second lithium salt including an inorganic anion. The organic anion may be an anion containing carbon, and the inorganic anion may be an anion not containing carbon. When the lithium salts include heterogeneous lithium salt compounds including different anions, the stability of the electrolyte layer including the cured product of the composition may be improved.

For example, the first lithium salt may be lithium bis(trifluoromethanesulfonyl)imide including (CF₃SO₂)₂N⁻, and the second lithium salt may be lithium nitrate including NO₃⁻.

In exemplary embodiments, the lithium salt may be contained in the organic solvent at a concentration of 0.01 M to 5 M, 0.01 M to 4 M, 0.5 M to 3 M, or 0.5 M to 2 M. Within this concentration range, the migration of lithium ions and/or electrons during charging and discharging of a lithium secondary battery may be facilitated, thereby improving the capacity and charge-discharge efficiency.

In exemplary embodiments, the contents of the first lithium salt and the second lithium salt may each independently be 0.01 M to 0.5 M with respect to the organic solvent. In some embodiments, the content of the second lithium salt may be greater than that of the first lithium salt.

In exemplary embodiments, the organic solvent may include a cyclic ether sol vent or a linear ether solvent. The cyclic ether solvent and the linear ether solvent may each independently include at least one ether group. For example, the cyclic ether solvent and the linear ether solvent may each include two or more ether groups.

For example, the cyclic ether solvent may include 1,3-dioxolane, 2-methyltetrahydrofuran, tetrahydrofuran or the like.

For example, the linear ether solvent may include 1,2-dimethoxyethane, dibutyl ether, tetraethylene glycol dimethyl ether, diethylene glycol dimethyl ether or the like.

These solvents may be used alone or in combination of two or more thereof.

According to exemplary embodiments, the ratio of the volume of the linear ether solvent to the volume of the cyclic ether solvent, based on the total volume of the organic solvent, may be 0.1 to 10. According to some embodiments, the ratio of the volume of the linear ether solvent to the volume of the cyclic ether solvent, based on the total volume of the organic solvent, may be 0.5 to 3.

According to exemplary embodiments, the organic solvent may further include a carbonate-based solvent, an ester-based solvent, a ketone-based solvent, an alcohol-based solvent, or an aprotic solvent. These solvents may be used alone or in combination of two or more thereof.

For example, the carbonate-based solvent may include propylene carbonate, ethylene carbonate, butylene carbonate, dimethyl carbonate, ethyl methyl carbonate, methyl propyl carbonate, ethyl propyl carbonate, diethyl carbonate, dipropyl carbonate or the like.

The ester-based solvent is distinguished from the carbonate-based solvent in that it includes an ester group rather than a carbonate group. For example, the ester-based solvent may include methyl acetate, ethyl acetate, n-propyl acetate, 1,1-dimethylethyl acetate, methyl propionate, ethyl propionate, γ-butyrolactone, decanolide, valerolactone, mevalonolactone, caprolactone or the like.

Examples of the ketone-based solvent may include cyclohexanone. Examples of the alcohol-based solvent may include ethyl alcohol, isopropyl alcohol or the like.

The aprotic solvent may include a nitrile solvent, an amide solvent such as dimethylformamide, a sulfolane solvent or the like.

The composition for forming a quasi-solid-state electrolyte according to exemplary embodiments may include an initiator. The initiator may initiate a polymerization reaction of the first monomer and the second monomer when energy is applied to the composition.

In exemplary embodiments, the initiator may include a thermal initiator or a photoinitiator.

For example, the thermal initiator may include benzoyl peroxide, dibenzoyl peroxide, succinic acid peroxide, dilauroyl peroxide, didecanoyl peroxide, dicumyl peroxide, di-t-butyl peroxide, di-t-amyl peroxide, α,α′-di(t-butylperoxy)diisopropylbenzene, 2,5-dimethyl-2,5-di(t-butylperoxy) hexane, 2,5-dimethyl-2,5-di(t-butylperoxy)-3-hexyne, t-butyl cumyl peroxide, α-cumyl peroxyneodecanoate, α-cumyl peroxyneopentanoate, t-amyl peroxyneodecanoate, t-butyl peroxyneodecanoate, di(2-ethylhexyl) peroxydicarbonate, t-amyl peroxypivalate, t-butyl peroxypivalate, 2,5-dimethyl-2,5-bis(2-ethylhexanoylperoxy) hexane, t-amyl peroxy-2-ethylhexanoate, t-butyl peroxy-2-ethylhexanoate, 1,1-di(t-amylperoxy)cyclohexane, 1,1-di(t-butylperoxy)-3,3,5-trimethylcyclohexane, 1,1-di(t-butylperoxy)cyclohexane, OO-t-amyl-O (2-ethylhexyl) monoperoxycarbonate, OO-t-butyl-O-isopropyl monoperoxycarbonate, OO-t-butyl-O (2-ethylhexyl) monoperoxycarbonate, t-amyl peroxybenzoate, t-butyl peroxyacetate, t-butyl peroxybenzoate, ethyl 3,3-di(t-amylperoxy) butyrate, ethyl 3,3-di(t-butylperoxy) butyrate, or dicumyl peroxide; and azo compounds such as 4,4′-azobis(4-cyanovaleric acid), 1,1′-azobis(cyclohexanecarbonitrile), azobisisobutyronitrile (AIBN), 2,2′-azobis(2-methylpropionamidine) dihydrochloride, 2,2′-azobis[2-(imidazolin-2-yl)propane]dihydrochloride, 2,2′-azobis[2-(2-imidazolin-2-yl)propane]disulfate dihydrate, 2,2′-azobis[N-(2-carboxyethyl)-2-methylpropionamidine]hydrate, 2,2′-azobis{2-[1-(2-hydroxyethyl)-2-imidazolin-2-yl]propane}dihydrochloride, 2,2′-azobis(1-imino-1-pyrrolidino-2-ethylpropane) dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)propionamide], cumene hydroperoxide, ammonium persulfate or the like. For example, the photoinitiator may include 2-hydroxy-2-methylpropiophenone, benzoin ethyl ether, benzoin isobutyl ether, benzoin methyl ether, dibenzosuberenone, 2,2-dimethoxy-2-phenylacetophenone, 3,4-dimethylbenzophenone, 3′-hydroxyacetophenone or the like.

In exemplary embodiments, the content of the initiator may be 0.1 to 10 parts by weight, based on 100 parts by weight of the total amount of the first monomer and the second monomer. In some embodiments, the content of the initiator may be 0.5 to 7 parts by weight, based on 100 parts by weight of the total amount of the first monomer and the second monomer.

In exemplary embodiments, the content of the thermal initiator may be 0.1 to 1 part by weight based on 100 parts by weight of the total amount of the first monomer and the second monomer.

In exemplary embodiments, the content of the photoinitiator may be 4 to 6 parts by weight based on 100 parts by weight of the total amount of the first monomer and the second monomer.

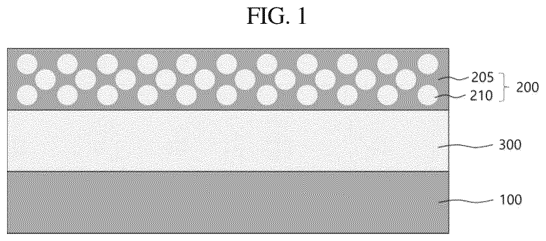

FIG. 1 is a schematic cross-sectional view illustrating a secondary battery according to an exemplary embodiment.

Referring to FIG. 1, the secondary battery includes an anode 100, a cathode 200, and an electrolyte layer 300.

The anode 100 may include a lithium metal layer. For example, the anode 100 may include a lithium foil or a lithium alloy layer. The lithium foil may have a thickness of, for example, 20 μm to 200 μm.

The cathode 200 may be disposed opposite to the anode 100. The cathode 200 includes a porous sulfur-containing matrix 205 having a plurality of pores. The porous sulfur-containing matrix may form the framework of the cathode 200.

The porous sulfur-containing matrix 205 may include a plurality of pores 210, and a cured product of the composition for forming a quasi-solid-state electrolyte may be contained within the pores 210.

The cathode 200 may be fabricated, for example, by applying the composition onto the surface of the porous sulfur-containing matrix 205 and curing the applied composition. The curing method may be thermal curing or photo-curing.

For example, the thermal curing may be performed by applying the composition onto the surface of the porous sulfur-containing matrix and maintaining the coated matrix at an elevated temperature.

For example, the photo-curing may be performed by applying the composition onto the surface of the porous sulfur-containing matrix and irradiating the coated surface with light. A light source used for the light irradiation is not particularly limited but may be, for example, a UV light source. The UV light source may have a wavelength of, for example, 380 nm to 410 nm and an intensity of 1,500 mW/cm² to 10,000 mW/cm².

The light irradiation may be performed for a period sufficient to cure the composition, for example, 20 to 60 seconds.

According to exemplary embodiments, unlike the configuration shown in FIG. 1, the cathode may include a cathode current collector and a cathode active material layer disposed on at least one surface of the cathode current collector. The cathode active material layer may include a sulfur-based active material.

The sulfur-based active material may include, for example, sulfur, a sulfur-carbon composite, which is a composite of sulfur and carbon-based conductive materials such as graphite, carbon black, acetylene black, Ketjen black, graphene, carbon nanotubes, vapor-grown carbon fibers (VGCF), or carbon fibers; a sulfur-polyacrylonitrile composite (S-PAN), lithium sulfide (Li₂S) or the like.

The cathode active material layer may further include a conductive material and/or a binder.

The binder may include polyvinylidene fluoride (PVDF), poly(vinylidene fluoride-co-hexafluoropropylene), polyacrylonitrile, polymethylmethacrylate, acrylonitrile butadiene rubber (NBR), poly(butadiene) rubber (BR), styrene-butadiene rubber (SBR), carboxymethyl cellulose (CMC), or the like.

The conductive material may be added to the cathode active material layer to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCF), and carbon fibers; and/or metal-based conductive materials such as tin, tin oxide, and titanium oxide; and perovskite materials such as LaSrCoO₃ and LaSrMnO₃, but is not limited thereto.

According to exemplary embodiments, the secondary battery includes the electrolyte layer 300 disposed between the anode 100 and the cathode 200. The electrolyte layer 300 may include a cured product of the composition for forming a quasi-solid-state electrolyte.

For example, the electrolyte layer 300 may be prepared by applying the composition onto a release film and curing the applied composition.

According to some embodiments, the electrolyte layer 300 may further include a porous polymer matrix. For example, the electrolyte layer 300 may include a porous polymer matrix having a plurality of pores and a cured product of the composition within the pores. The porous polymer matrix is not particularly limited but may include, for example, a porous polyethylene nonwoven fabric.

For example, the electrolyte layer 300 may be prepared by applying the composition onto the surface of the porous polymer matrix and curing the applied composition. The curing method may be thermal curing or photo-curing.

For example, thermal curing may be performed by applying the composition onto the surface of the porous polymer matrix and maintaining the coated matrix at an elevated temperature.

For example, photo-curing may be performed by applying the composition onto the surface of the porous polymer matrix and irradiating the coated surface with light. A light source used for the light irradiation is not particularly limited but may be, for example, a UV light source. The UV light source may have a wavelength of, for example, 380 nm to 410 nm and an intensity of 1,500 mW/cm² to 10,000 mW/cm².

The light irradiation may be performed for a period sufficient to cure the composition, for example, 20 to 60 seconds.

In exemplary embodiments, the cured product of the composition for forming a quasi-solid-state electrolyte may include a copolymer formed from the first monomer and the second monomer. The curing may be performed by applying energy, and a polymerization reaction of the first monomer and the second monomer may proceed under the action of the initiator. Accordingly, a copolymer of the first monomer and the second monomer may be formed.

According to exemplary embodiments, the electrolyte layer may be formed through an in situ process. For example, the secondary battery may be manufactured by inserting a preliminary electrode assembly obtained by stacking a porous sulfur-containing matrix, a porous polymer matrix, and an anode into an outer case, injecting the composition, and then curing it. In this case, the curing may be performed by thermal curing.

The secondary battery according to exemplary embodiments may be a lithium-sulfur battery. The lithium-sulfur battery may form lithium polysulfides as byproducts during repeated charge and discharge cycles. The secondary battery according to exemplary embodiments may include a cured product of the composition, and the cured product may include a copolymer of the first monomer and the second monomer. The ionic functional groups of the first monomer may have high reactivity with lithium polysulfides, thereby reducing the accumulation of lithium polysulfides within the battery. Accordingly, the cycle life characteristics of the battery may be improved.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

A composition for forming a quasi-solid-state electrolyte was prepared by mixing 87 parts by weight of a liquid electrolyte containing 0.1 M lithium bis(trifluoromethanesulfonyl)imide and 0.3 M lithium nitrate dissolved in a solvent including 1,3-dioxolane and 1,2-dimethoxyethane in a 1:1 volume ratio; 3 parts by weight of 3-(triallylammonio) propanesulfonate as a first monomer, 10 parts by weight of ethoxylated trimethylolpropane triacrylate as a second monomer, and 0.65 parts by weight of 2-hydroxy-2-methylpropiophenone as an initiator.

The composition was applied onto the surface of a porous sulfur-containing matrix, and the coated surface was irradiated with UV light (wavelength: 400 nm, intensity: 5,000 mW/cm²) for 40 seconds to fabricate a cathode.

The composition was then applied to the surface of a porous polyethylene nonwoven fabric, and the coated surface was irradiated with UV light (wavelength: 400 nm, intensity: 5,000 mW/cm²) for 40 seconds to prepare an electrolyte layer.

The electrolyte layer was stacked on the cathode, and a lithium foil (thickness: 100 μm) was laminated thereon to form an electrode assembly. The electrode assembly was then placed in a pouch-type outer case and sealed to manufacture a battery.

### Example 2

A composition was prepared in the same manner as in Example 1, except that 0.13 parts by weight of azobisisobutyronitrile was used as an initiator instead of 2-hydroxy-2-methylpropiophenone.

A porous sulfur-containing electrode, a porous polyethylene nonwoven fabric, and a lithium foil were sequentially stacked to form a preliminary electrode assembly. The electrode assembly was placed in a pouch-type outer case, and three sides of the case were sealed, leaving one side open for injection of the composition. After injecting the composition through the open side, the remaining side was sealed, and the assembly was maintained at 60° C. for 3 hours to manufacture a battery.

### Comparative Example 1

A porous sulfur-containing electrode, a porous polyethylene nonwoven fabric, and a lithium foil were sequentially stacked to form a preliminary electrode assembly. The electrode assembly was placed in a pouch-type outer case, and three sides of the case were sealed, leaving one side open for injection of the electrolyte.

A liquid electrolyte containing 0.1 M lithium bis(trifluoromethanesulfonyl)imide and 0.3 M lithium nitrate dissolved in a solvent including 1,3-dioxolane and 1,2-dimethoxyethane in a 1:1 volume ratio was injected through the open side, and the remaining side was sealed to manufacture a battery.

### Comparative Example 2

A composition and a battery were manufactured in the same manner as in Example 1, except that the first monomer was not included in the composition.

### Experimental Example: Evaluation of Battery Cycle Life Characteristics

The batteries of the examples and comparative examples were charged at a current density of 0.1 C to a final voltage of 2.7 V and discharged at a current density of 0.1 C to a final voltage of 1.7 V. This process was defined as one cycle, and formation charge and discharge were performed. Subsequently, 150 charge-discharge cycles were repeatedly performed at a current density of 0.5 C to a final voltage of 2.7 V for charging and at a current density of 0.5 C to a final voltage of 1.7 V for discharging. The coulombic efficiency and capacity per sulfur weight of each battery were measured as a function of the number of cycles.

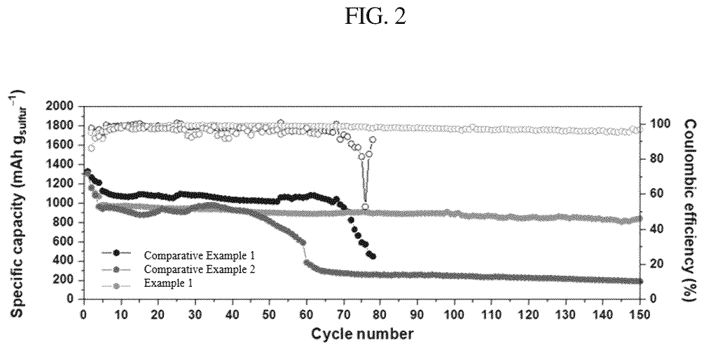

FIG. 2 is a graph illustrating the capacity and coulombic efficiency as a function of the number of cycles for the batteries of Example 1, and Comparative Examples 1 and 2.

Referring to FIG. 2, the battery of Example 1 maintained its capacity and coulombic efficiency at levels similar to the initial values even after repeated charge-discharge cycles. In contrast, the battery of Comparative Example 1, which included a liquid electrolyte, exhibited a sharp decrease in capacity at approximately 80 cycles, and the battery of Comparative Example 2, which was manufactured without an ionic monomer, exhibited a sharp decrease in capacity at approximately 50 cycles.

The contents described above are merely examples of applying the principles of the present disclosure, and other configurations may be further included without departing from the scope of the present disclosure.

What is claimed is:

1. A composition for forming a quasi-solid-state electrolyte comprising:
a liquid electrolyte including a lithium salt and an organic solvent;
a first monomer having an ionic functional group;
a second monomer different from the first monomer and having a crosslinkable functional group; and
an initiator.

2. The composition for forming a quasi-solid-state electrolyte according to claim 1, wherein the first monomer includes an anionic functional group; a cationic functional group; or both anionic and cationic functional groups.

3. The composition for forming a quasi-solid-state electrolyte according to claim 1, wherein the first monomer includes a nitrogen-based cationic functional group and a sulfur-based anionic functional group.

4. The composition for forming a quasi-solid-state electrolyte according to claim 1, wherein the first monomer includes 3-(triallylammonio) propanesulfonate.

5. The composition for forming a quasi-solid-state electrolyte according to claim 1, wherein the content of the first monomer is 0.1% by weight to 5% by weight based on the total weight of the composition for forming a quasi-solid-state electrolyte.

6. The composition for forming a quasi-solid-state electrolyte according to claim 1, wherein the crosslinkable functional group includes (meth)acrylate group.

7. The composition for forming a quasi-solid-state electrolyte according to claim 1, wherein the second monomer includes at least one selected from the group consisting of bisphenol A ethoxylated di(meth)acrylate, ethylene glycol di(meth)acrylate, triethylene glycol di(meth)acrylate, ethoxylated trimethylolpropane tri(meth)acrylate, (meth)acrylic acid, carboxyethyl di(meth)acrylate, cyano(meth)acrylic acid, propylene glycol di(meth)acrylate, polyurethane di(meth)acrylate, neopentyl glycol di(meth)acrylate, isobornyl di(meth)acrylate, isophorone di(meth)acrylate, hexamethylene di(meth)acrylate, phenyl glycidyl ether di(meth)acrylate, and tetraethylene glycol di(meth)acrylate.

8. The composition for forming a quasi-solid-state electrolyte according to claim 1, wherein the content of the second monomer is 5% by weight to 20% by weight based on the total weight of the composition for forming a quasi-solid-state electrolyte.

9. The composition for forming a quasi-solid-state electrolyte according to claim 1, wherein the ratio of the weight of the second monomer to the weight of the first monomer based on the total weight of the composition for forming a quasi-solid-state electrolyte is 1 to 10.

10. The composition for forming a quasi-solid-state electrolyte according to claim 1, wherein the initiator includes a thermal initiator or a photoinitiator.

11. The composition for forming a quasi-solid-state electrolyte according to claim 1, wherein the content of the initiator is 0.1 to 10 parts by weight based on 100 parts by weight of the total amount of the first monomer and the second monomer.

12. The composition for forming a quasi-solid-state electrolyte according to claim 1, wherein the lithium salt comprises a first lithium salt including an organic anion and a second lithium salt including an inorganic anion.

13. The composition for forming a quasi-solid-state electrolyte according to claim 1, wherein the organic solvent includes a cyclic ether solvent and a linear ether solvent.

14. A secondary battery comprising:
an anode;
a cathode disposed opposite to the anode; and
an electrolyte layer disposed between the anode and the cathode and including a cured product of a composition for forming a quasi-solid-state electrolyte,
wherein the cathode comprises a porous sulfur-containing matrix having a plurality of pores and a cured product of the composition for forming a quasi-solid-state electrolyte within the plurality of pores,
wherein the composition for forming a quasi-solid-state electrolyte comprises:
a liquid electrolyte including a lithium salt and an organic solvent;
a first monomer having an ionic functional group;
a second monomer different from the first monomer and having a crosslinkable functional group; and
an initiator.

15. The secondary battery according to claim 14, wherein the cured product of the composition for forming a quasi-solid-state electrolyte includes a copolymer of the first monomer and the second monomer.
